(19) United States
(12) Patent Application Publication
(10) Pub. No.: US 2026/0236764 A1
(43) Pub. Date: Aug. 13, 2026

(54) ENSEMBLE MULTI-DIRECTIONAL ANOMALY AND SCENARIO SHIFT DETECTION FOR FLUID-NETWORKS

(71) Applicant: Endress+Hauser Flowtec AG, Reinach (CH)

(72) Inventors: Rebecca Page, Basel (CH); Stephan Wernli, Reinach (CH)

(21) Appl. No.: 19/142,284

(22) PCT Filed: Dec. 14, 2023
(86) PCT No.: PCT/EP2023/085779

§ 371 Date: Jun. 23, 2025

(30) Foreign Application Priority Data
Dec. 21, 2022 (DE) 10 2022 134 267.0

(51) Int. Cl. G06N 3/08; G01M 3/02

(52) U.S. Cl. CPC G06N 3/08; G01M 3/02

(57) ABSTRACT

A data-driven method for continuously monitoring fluid in a fluid network triggers an alert in case of unexpected characteristics of the fluid. The method comprises a step of measuring one or more physical quantities at each of three or more measurement units, separately, said physical quantities being relevant to fluid transport. The measurement units are located at three or more different locations and each comprise one or more sensors for determining one or more measured values of the physical quantities. The physical quantities are time dependent and each of said measured values is determined continuously in a predefined measurement time interval. The method also includes transmitting said measured values to a data processing unit to determine, for each measurement unit, an observed time series of measured values of each physical quantity, and using the data processing unit to process description steps, estimation steps, and evaluation steps.

The invention relates to a data-driven method for continuously monitoring fluid in a fluid network and triggering an alert in case of unexpected characteristics of the fluid and to a system for carrying out the method.

Leakage in networks with fluids, such as water distribution networks, leads to loss of both resource and energy. Losses of fluid in the form of treated/purified water are therefore losses of revenue to the utilities of the water industry. Losses of other forms of fluids, e.g., wastewater, can also lead to environmental degradation.

Fluid losses can have several causes, e.g., losses due to leaking pipes and other components of the network infrastructure, incorrect or missing measurements, or unexpected and undocumented consumption. Incorrect measurements due to sensor failures mean loss of information, which is accompanied by a loss of control.

Unexpected water consumption, for example, can be a drain on networks and their infrastructure, as well as a sign of unauthorized consumption, and thus loss of revenue. Common methods of detecting unexpected consumption include mass balancing of pipe networks or areas, e.g., District Metered Areas (DMA), monitoring of minimum night flow, simulation of the pipe network using hydraulic models, forecasting using artificial neural networks to predict expected consumption at key points.

These methods often require a detailed knowledge of the individual distribution networks, such as individual meters, timestamps, and locations. Currently available data-driven solutions rely mainly on the application of user-specific thresholds, which must be entered manually.

The object of the present invention is to provide a data-driven method for monitoring fluid in a fluid network with a holistic view and detecting of irregularities of the characteristics of the fluid in the fluid network.

The object is achieved by the method specified in independent claim 1 and the system described in claim 11 for carrying out the method.

Method-wise the object is solved with the following steps:
a) Measuring one or more physical quantities at each of three or more measurement units, separately, said physical quantities are relevant to fluid transport, said measurement units are located at three or more different locations in said fluid network, respectively, each of the measurement units comprising one or more sensors for determining one or more measured values of the physical quantities, wherein the physical quantities are time dependent and each of said measured values is determined continuously in a predefined measurement time interval,
b) transmitting said measured values to a data processing unit,
c) using said data processing unit to determine, for each measurement unit, an observed time series of measured values of each physical quantity,
d) and using the data processing unit to process:
one or more description steps, comprising:
   decomposing each observed time series,
   fitting each observed time series with a time series model,
   performing one or more statistical hypothesis tests for said time series model,
   and measuring one or more statistical distances between every two different observed time series,
one or more estimation steps, comprising:
   determining a time-sensitive neural network that is trained based on historical observed time series of the one or more physical quantities from all measurement units,
   and using said time-sensitive neural network to process an estimation:
   estimating, for each measurement unit, an estimated time series of each physical quantity, and using said time-sensitive neural network to process an estimation: estimating, for each measurement unit (MU), an estimated time series of each physical quantity, wherein for each estimation, all measurement units (MUs) are divided into the measurement unit (MU) being estimated and the remaining measurement units (MUs), wherein the observed time series of each physical quantity from the remaining measurement units (MUs) are used to estimate the estimated time series of each corresponding physical quantity from the measurement unit (MU) being estimated, the estimated time series comprising estimates for all measured values of each corresponding physical quantity,
and one or more evaluation steps, comprising:
   determining, for each measurement unit, a deviation between each measured value of each physical quantity and each of said estimates,
   gathering said statistical distances determined from said one or more description steps, if one or more predetermined limit values of said deviation are exceeded,
   quantifying effect of disturbance causing deviation in affected measurement units and rating proximity of measurements units to disturbance source,
   retraining the time-sensitive neural network, if more than one predetermined limit values of said statistical distances are exceeded,
   and outputting an alert, if at least one but not all predetermined limit values of the statistical distances are exceeded.

Advantageously, the one or more physical quantities comprise at least one of: flow, temperature, level, and pressure. The one or more physical quantities are indicative of the characteristics of the fluid.

In one embodiment, the data processing unit is in a control center at a distance.

In one embodiment, the time series model comprises at least one of: an autoregressive (AR) model, an autoregressive moving average (ARMA) model, an autoregressive integrated moving average (ARIMA) model, and an autoregressive fractionally integrated moving average (ARFIMA) model.

In one embodiment, the one or more statistical hypothesis tests comprise a Dickey-Fuller test.

In one embodiment, the one or more statistical distances comprise a Kullback-Leibler divergence.

In one embodiment, the time-sensitive neural network comprises at least one of: a recurrent neural network (RNN), a Long short-term memory (LSTM), and a transformer. In one embodiment, the estimation comprises at least one of: a sequence approach and a sequence-to-sequence approach.

In one embodiment, the evaluation step comprises a cluster analysis of the measured values of the observed time series and/or the phase shifts of the observed time series if one or more predetermined limit values of the deviation are exceeded.

In one embodiment, the alert relates to at least one of: an abnormal characteristic of the fluid in certain measurement time ranges, an abnormal characteristic of the fluid located between at least two measurement units, and a failure of sensor.

The object is further attained by a system for carrying out the method described above, comprising:
a) a fluid network,
b) three or more measurement units located at three or more different locations in said fluid network, respectively, each of the measurement units comprising one or more sensors for determining one or more measured values of one or more physical quantities, said physical quantities are relevant to fluid transport, and the physical quantities are time dependent and each of said measured values is determined continuously in a predefined measurement time interval,
c) and a data processing unit used for receiving said measured values, wherein said data processing unit is configured to determine, for each measurement unit, an observed time series of measured values of each physical quantity, and the data processing unit is configured to process:
one or more description steps, comprising:
   decomposing each observed time series,
   fitting each observed time series with a time series model,
   performing one or more statistical hypothesis tests for said time series model,
   and measuring one or more statistical distances between every two different observed time series,
one or more estimation steps, comprising:
   determining a time-sensitive neural network that is trained based on historical observed time series of the one or more physical quantities from all measurement units,
   and using said time-sensitive neural network to process an estimation:

estimating, for each measurement unit, an estimated time series of each physical quantity, and using said time-sensitive neural network to process an estimation: estimating, for each measurement unit (MU), an estimated time series of each physical quantity, wherein for each estimation, all measurement units (MUs) are divided into the measurement unit (MU) being estimated and the remaining measurement units (MUs), wherein the observed time series of each physical quantity from the remaining measurement units (MUs) are used to estimate the estimated time series of each corresponding physical quantity from the measurement unit (MU) being estimated, the estimated time series comprising estimates for all measured values of each corresponding physical quantity,
and one or more evaluation steps, comprising:
   determining, for each measurement unit, a deviation between each measured value of each physical quantity and each of said estimates,
   gathering said statistical distances determined from said one or more description steps, if one or more predetermined limit values of said deviation are exceeded,
   quantifying effect of disturbance causing deviation in affected measurement units and rating proximity of measurements units to disturbance source,
   retraining the time-sensitive neural network, if more than one predetermined limit values of said statistical distances are exceeded,
   and outputting an alert, if at least one but not all predetermined limit values of the statistical distances are exceeded.

This is explained in more detail with reference to the following figures.

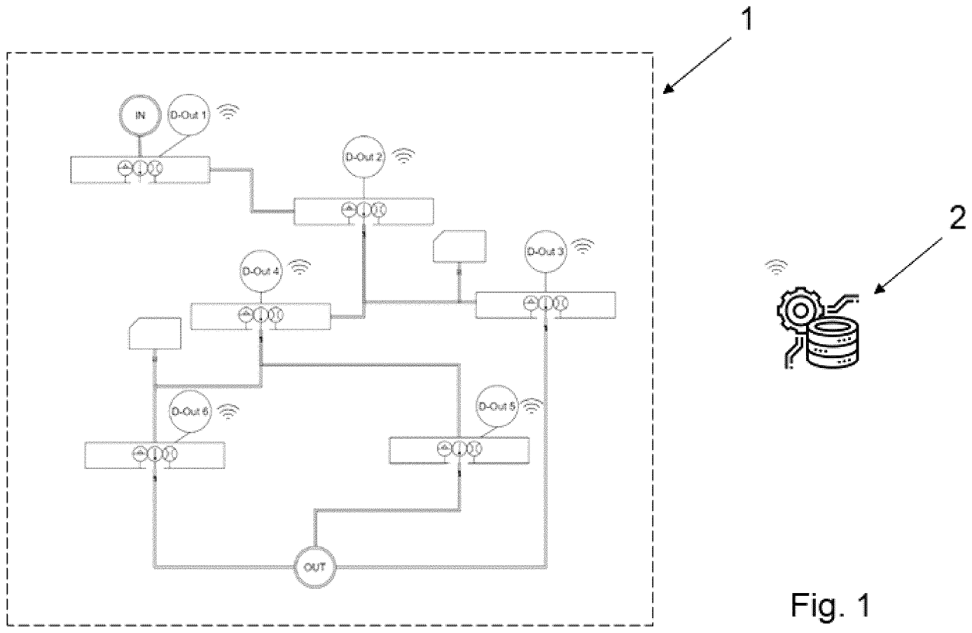

FIG. 1 shows an embodiment of the fluid network and the data processing unit.

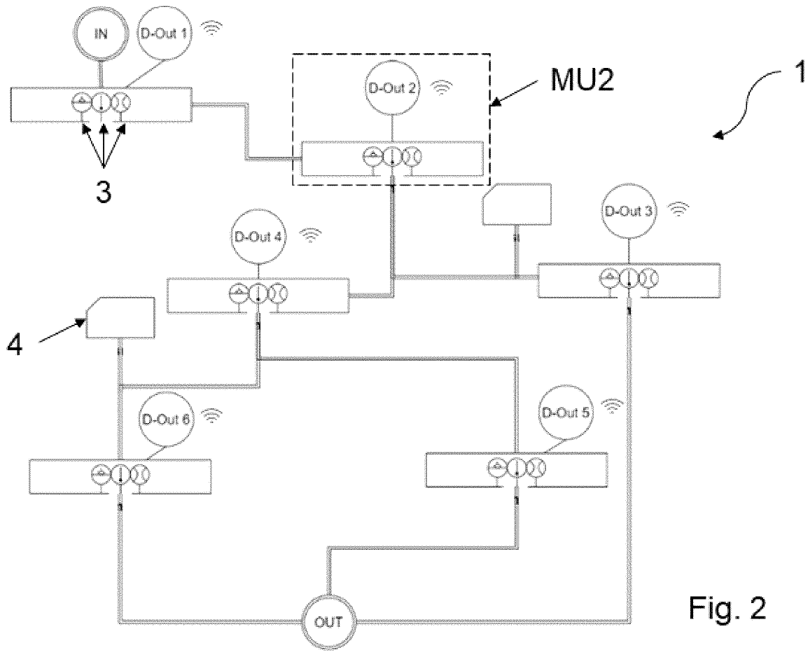

FIG. 2 shows the components of the fluid network.

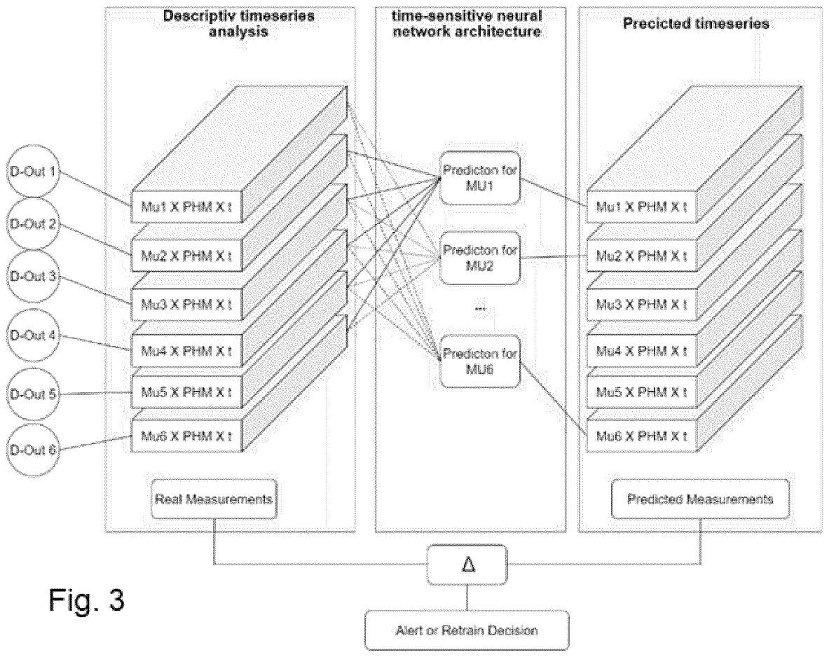

FIG. 3 shows an embodiment of the time-sensitive neural network.

In the figures, the same features are marked with the same reference signs.

Referring to FIG. 1, a fluid network 1 communicates with a data processing unit 2. The communication between the fluid network 1 and the data processing unit 2 could using wire or wirelessly. The fluid network 1 could be a water distribution network or an oil and gas transportation network. The data processing unit 2 could be an edge computer or a cloud data service.

In FIG. 2, the fluid network 1 comprises an entry-described as IN-of a fluid into the network, and an exit-described as OUT-of the fluid from the network. The fluid network 1 comprises six measurement units (MU1, MU2, MU3, MU4, MU5, MU6) and two consumers 4, all located in different locations.

Each measurement unit (MU) comprises three sensors 3, e.g., a flow meter, a pressure sensor, and a temperature sensor. The three sensors 3 measure three physical quantities, e.g., flow, pressure, and temperature, respectively, continuously in a predefined measurement time interval. Flow, pressure, and temperature are indicative of a leakage of water in a water network.

Each MU communicates with the data processing unit 2 (see FIG. 1), transferring the measured values of the flow, pressure, and temperature from each MU to the data processing unit 2. D-Out describes a data interface to the logic module of the invention, e.g., the data processing unit 2. So, the measured values are transmitted through the data interface—D-Out—to the data processing unit 2.

Referring to FIG. 3, the data processing unit 2 receives measured values from each MU. The data processing unit 2 is configured to determine, for each measurement unit 3, three observed time series of measured values (Real Measurements in FIG. 3) of the flow, pressure, and temperature, respectively. In the data processing unit 2, PHM represents Parameter Health Monitoring, which includes all measured values that can be provided by a MU. On the left (Real Measurements) of FIG. 3, the box named “Mu1 X PHM X t” means all measured values and their measurement times that can be provided by the measurement unit 1 (MU1).

The data processing unit 2 is configured to process a descriptive timeseries analysis comprising, e.g., four descriptive steps.

The four descriptive steps comprising a decomposition of each observed time series into several component series, for example, a trend component, a seasonal component, and a noise component. The data processing unit 2 fits each observed time series with a time series model, for example, an autoregressive integrated moving average (ARIMA) model. A statistical hypothesis test, e.g., a Dickey-Fuller test, is then performed for each time series model. And a statistical distance is measured between every two different observed time series. The statistical distance could be a Kullback-Leibler divergence.

In the estimation steps, the data processing unit 2 first determines a time-sensitive neural network that is trained based on historical observed time series of the flow, pressure, and temperature from all measurement units (MUs). The data processing unit 2 then uses the time-sensitive neural network to process a prediction/estimation: estimating, for each MU, three predicted/estimated time series, one for flow, one for pressure, and one for temperature. When estimating the estimated time series, the estimated time series of the physical quantity is estimated only by the observed time series of the corresponding physical quantity, so there is no case of estimating the third physical quantity by the first and second physical quantities. In addition, the data processing unit 2 further divides all MUs into the MU being estimated and the remaining MUs, wherein the observed time series of the physical quantities from the remaining MUs are used to estimate the estimated time series of the corresponding physical quantity from the MU being estimated (Predicted Measurements in FIG. 3). For example, the estimated time series of flow at the MU1 is estimated based on all observed time series of flow that are recorded by MU2, MU3, MU4, MU5, and MU6 rather than MU1.

The time-sensitive neural network is not used to estimate a new physical quantity, but one that is already available in other and the same measurement unit (MU), so that it is able to provide proxy information for faulty measurements of individual sensors in the network.

An evaluation (4) comprising one or more evaluation steps are followed the estimation steps. It determines, for each MU, a deviation between each measured value of each physical quantity and each of the estimates. In the evaluation, if one or more predetermined limit values of the deviation are exceeded, the data processing unit 2 then gathers the statistical distances determined from the description steps. The data processing unit 2 quantifies the effect of a disturbance causing deviation in affected MUs and rating proximity of MUs to the disturbance source. If more than one predetermined limit values of said statistical distances are exceeded, the data processing unit 2 retrains the time-sensitive neural network. An expert (e.g., a user or operator of a facility) can stop the retraining, if the estimation results are considered sufficiently accurate. And the data processing unit 2 outputs an alert, if at least one but not all predetermined limit values of the statistical distances are exceeded.

### List of Reference Signs

1 Fluid network
2 Data processing unit
3 Sensor
4 Consumer
MU2 Measurement unit 2

1-11. (canceled)

12. A data-driven method for continuously monitoring fluid in a fluid network and triggering an alert in case of unexpected characteristics of the fluid, comprising:
measuring one or more physical quantities at each of three or more measurement units, separately, said physical quantities are relevant to fluid transport, said measurement units are located at three or more different locations in said fluid network, respectively, each of the measurement units comprising one or more sensors for determining one or more measured values of the physical quantities, wherein the physical quantities are time dependent and each of said measured values is determined continuously in a predefined measurement time interval,
transmitting said measured values to a data processing unit,
using said data processing unit to determine, for each measurement unit, an observed time series of measured values of each physical quantity, and
using the data processing unit to process:
one or more description steps, comprising:
decomposing each observed time series,
fitting each observed time series with a time series model, performing one or more statistical hypothesis tests for said time series model, and
measuring one or more statistical distances between every two different observed time series,
one or more estimation steps, comprising:
determining a time-sensitive neural network that is trained based on historical observed time series of the one or more physical quantities from all measurement units, and
using said time-sensitive neural network to process an estimation: estimating, for each measurement unit, an estimated time series of each physical quantity, wherein for each estimation, all measurement units are divided into the measurement unit being estimated and the remaining measurement units, wherein the observed time series of each physical quantity from the remaining measurement units are used to estimate the estimated time series of each corresponding physical quantity from the measurement unit being estimated, the estimated time series comprising estimates for all measured values of each corresponding physical quantity,
and one or more evaluation steps, comprising:
determining, for each measurement unit, a deviation between each measured value of each physical quantity and each of said estimates,
gathering said statistical distances determined from said one or more description steps, if one or more predetermined limit values of said deviation are exceeded,
quantifying effect of disturbance causing deviation in affected measurement units and rating proximity of measurements units to disturbance source,
retraining the time-sensitive neural network, if more than one predetermined limit values of said statistical distances are exceeded,
and outputting an alert, if at least one but not all predetermined limit values of the statistical distances are exceeded.

13. The method according to claim 12, wherein the one or more physical quantities comprise at least one of flow, temperature, level, and pressure.

14. The method according to claim 12, wherein the data processing unit is in a control center at a distance.

15. The method according to claim 12, wherein the time series model comprises at least one of an autoregressive model, an autoregressive moving average model, an autoregressive integrated moving average model, and an autoregressive fractionally integrated moving average model.

16. The method according to claim 12, wherein the one or more statistical hypothesis tests comprise a Dickey-Fuller test.

17. The method according to claim 12, wherein the one or more statistical distances comprise a Kullback-Leibler divergence.

18. The method according to claim 12, wherein the time-sensitive neural network comprises at least one of: a recurrent neural network, a Long short-term memory, and a transformer.

19. The method according to claim 12, wherein the estimation comprises at least one of a sequence approach and a sequence-to-sequence approach.

20. The method according to claim 12, wherein the evaluation step comprises a cluster analysis of the measured values of the observed time series and/or the phase shifts of the observed time series if one or more predetermined limit values of the deviation are exceeded.

21. The method according to claim 12, wherein the alert relates to at least one of an abnormal characteristic of the fluid in certain measurement time ranges, an abnormal characteristic of the fluid located between at least two measurement units, and a failure of sensor.

22. A system for continuously monitoring fluid in a fluid network and triggering an alert in case of unexpected characteristics of the fluid, including:
a fluid network,
three or more measurement units located at three or more different locations in said fluid network, respectively, each of the measurement units comprising one or more sensors for determining one or more measured values of one or more physical quantities, said physical quantities are relevant to fluid transport, and the physical quantities are time dependent and each of said measured values is determined continuously in a predefined measurement time interval, and
a data processing unit used for receiving said measured values, wherein said data processing unit is configured to determine, for each measurement unit, an observed time series of measured values of each physical quantity, and the data processing unit is configured to process:
one or more description steps, comprising:
decomposing each observed time series,
fitting each observed time series with a time series model,
performing one or more statistical hypothesis tests for said time series model, and
measuring one or more statistical distances between every two different observed time series,
one or more estimation steps, comprising:
determining a time-sensitive neural network that is trained based on historical observed time series of the one or more physical quantities from all measurement units, and
using said time-sensitive neural network to process an estimation: estimating, for each measurement unit, an estimated time series of each physical quantity, and using said time-sensitive neural network to process an estimation: estimating, for each measurement unit, an estimated time series of each physical quantity, wherein for each estimation, all measurement units are divided into the measurement unit being estimated and the remaining measurement units, wherein the observed time series of each physical quantity from the remaining measurement units are used to estimate the estimated time series of each corresponding physical quantity from the measurement unit being estimated, the estimated time series comprising estimates for all measured values of each corresponding physical quantity,
and one or more evaluation steps, comprising:
determining, for each measurement unit, a deviation between each measured value of each physical quantity and each of said estimates,
gathering said statistical distances determined from said one or more description steps, if one or more predetermined limit values of said deviation are exceeded,
quantifying effect of disturbance causing deviation in affected measurement units and rating proximity of measurements units to disturbance source,
retraining the time-sensitive neural network, if more than one predetermined limit values of said statistical distances are exceeded, and
outputting an alert, if at least one but not all predetermined limit values of the statistical distances are exceeded.
